(19) United States
(12) Patent Application Publication
(10) Pub. No.: US 2014/0356685 A1
(43) Pub. Date: Dec. 4, 2014

(54) ASSEMBLED CELL

(71) Applicant: SANYO Electric Co., Ltd., Moriguchi-shi, Osaka (JP)

(72) Inventors: Hiroyuki Okuda, Osaka (JP); Yoshito Kaga, Osaka (JP); Shigeki Matsuta, Hyogo (JP); Hiroshi Kondo, Osaka (JP)

(73) Assignee: SANYO ELECTRIC CO., LTD., Moriguchi-shi, Osaka (JP)

(21) Appl. No.: 14/344,732

(22) PCT Filed: Sep. 24, 2012
(86) PCT No.: PCT/JP2012/074381

§ 371 Date: Mar. 13, 2014

(30) Foreign Application Priority Data
Sep. 30, 2011 (JP) 2011-218294

(51) Int. Cl. H01M 10/656; H01M 10/623; H01M 10/647

(52) U.S. Cl. CPC H01M 10/5061; H01M 10/5032; H01M 10/5012
USPC 429/120

(57) ABSTRACT

To provide an assembled cell in which problems such as the fast deterioration of only some unit cells positioned in a middle part are solved by realizing smooth heat dissipation from the middle part of the cell even if an outer member is made of a flexible material. A first heat transfer member 6 including bag members 6a made of polycarbonate and filled with silicone gel is provided between a housing 2 and a unit cell assembly 5 in which a plurality of unit cells 10 are stacked, and in a middle part in a direction of stacking of the unit cells 10. The unit cells 10 are each provided with an outer member 18 made of aluminum laminate film.

### TECHNICAL FIELD

The present invention relates to an assembled cell.

### BACKGROUND ART

Power supplies included in, for example, a robot, a motorcycle, a small electrically powered mobile apparatus, and so forth are each housed in a limited space and are therefore desired to be small and light and to cost low, for example. As an option that meets such desires, lithium ion cells each having a high energy density have been attracting attention in recent years. To provide high power with such a lithium ion cell, many unit cells, for example, about five or six unit cells to about twenty unit cells, are arranged side by side and are connected in series or in parallel, thereby being used as an assembled cell.

An assembled cell for the above uses, however, is used at a high rate, and each of the unit cells generates heat at times of charging and discharging. If such an assembled cell is provided in a limited space as described above, the heat cannot be dissipated into the air. Therefore, the temperature tends to rise. In this case, it is sometimes difficult to provide a forced air-cooling mechanism such as a fan. Hence, it is highly possible that the heat needs to be dissipated by utilizing the thermal conduction or heat radiation from a solid body to the outside.

Typically, in an assembled cell including a plurality of unit cells, the temperatures of some unit cells that are positioned in a middle part in a direction of arrangement of the unit cells (a stacking direction if the unit cells are stacked vertically) tend to rise easily. This is because the areas of heat dissipation of the unit cells positioned in the middle part are limited compared with those of unit cells positioned at the ends. Consequently, a problem arises in that only the unit cells in the middle part deteriorate fast because of the rise of the temperatures thereof.

Accordingly, a storage battery has been disclosed (see PTL 1 given below) in which at least three or more unit cells are housed in respective cell chambers of an electrolytic bath that are arranged in a row with partitions interposed therebetween, and a metal plate whose surface area gradually increases in the direction of the row from two ends thereof toward the center thereof is attached to an outer surface, extending in the direction of the row, of the electrolytic bath.

### CITATION LIST

### Patent Literature

PTL 1: Japanese Published Unexamined Patent Application No. 11-213962

### SUMMARY OF INVENTION

### Technical Problem

If an outer member (corresponding to the electrolytic bath according to PTL 1) of each unit cell is made of a material not having flexibility (a material that is not deformable by pressure or the like), a large area of contact between the outer member and the metal plate is provided (establishing a state where only a small amount of air, which has low thermal conductivity, is present between the outer member and the metal plate). Therefore, the heat dissipation from the middle part of the storage battery may be realized relatively smoothly. However, if the outer member of the unit cell is made of a flexible material (for example, if the outer member is made of aluminum laminate film), the outer member is easily deformable by pressure or the like. Hence, the area of contact between the metal plate that is difficult to deform and the outer member is small, and the smooth heat dissipation from the middle part of the battery is hindered. Consequently, the problem of the faster deterioration of the unit cells positioned in the middle part than the unit cells positioned at the ends remains unsolved.

### Solution to Problem

An assembled cell according to the present invention includes a housing having a closed-end rectangular cylindrical shape; a unit cell assembly housed in the housing and in which a plurality of unit cells each having a rectangular shape in plan view are arranged side by side, the unit cell being provided with a flexible outer member; and a first heat transfer member including a flexible bag member filled with a heat-transferring substance having fluidity, the first heat transfer member being configured to transfer heat generated from the unit cells to the housing. At least one of side faces of the unit cell assembly is provided with a connecting portion in which current-collecting terminals projecting from the respective unit cells are connected to one another. The first heat transfer member is provided between at least one of the side faces of the unit cell assembly, excluding the side face of the unit cell assembly that is provided with the connecting portion, and a side face of the housing that is adjacent to the side face of the unit cell assembly. The first heat transfer member is positioned in a middle part in a direction of arrangement of the unit cells.

### Advantageous Effects of Invention

According to the present invention, the assembled cell including the unit cells provided with the flexible outer members produces a highly advantageous effect of suppressing the fast deterioration of only the unit cells positioned in the middle part.

### BRIEF DESCRIPTION OF DRAWINGS

FIG. 1 is a perspective view of an assembled cell according to an embodiment of the present invention.

FIG. 2 is an exploded perspective view of the assembled cell according to the embodiment of the present invention.

FIG. 3 is a perspective view of a unit cell.

FIG. 4 is a perspective view of a unit cell assembly.

FIG. 5 is a perspective view of a first heat transfer member.

FIG. 6 is a perspective view of a housing.

FIG. 7 is a plan view of the assembled cell with an outer lid and an inner lid removed.

FIG. 8 is a front view of the assembled cell with the outer lid and a front sidewall of the housing removed.

FIG. 9 is a side view of the assembled cell with the outer lid and a lateral sidewall of the housing removed.

FIG. 10 is a perspective view illustrating directions of good thermal conduction of the unit cell.

FIG. 11 is a plan view of an assembled cell according to a modification with an outer lid and an inner lid removed.

FIG. 12 is a front view of the assembled cell according to the modification with the outer lid and a front sidewall of the housing removed.

FIG. 13 is a front view of an assembled cell according to another modification with an outer lid and a front sidewall of the housing removed.

FIG. 14 is a side view of the assembled cell according to the modification with the outer lid and a lateral sidewall of the housing removed.

FIG. 15 is a perspective view of a housing included in an assembled cell according to yet another modification.

FIG. 16 is a perspective view of a housing included in an assembled cell according to yet another modification.

FIG. 17 is a perspective view of a housing included in an assembled cell according to yet another modification.

FIG. 18 is a perspective view of a housing included in an assembled cell according to yet another modification.

FIG. 19 is a perspective view of a second supporting projection included in an assembled cell according to yet another modification.

FIG. 20 is a perspective view of a pressing member included in an assembled cell according to yet another modification.

FIG. 21 is a perspective view of a pressing member included in an assembled cell according to yet another modification.

FIG. 22 is a graph illustrating the relationship between each of different parts of a unit cell assembly and the temperature thereof in each of Cells A, Z1, and Z2.

### DESCRIPTION OF EMBODIMENTS

An assembled cell according to the present invention includes a housing having a closed-end rectangular cylindrical shape; a unit cell assembly housed in the housing and in which a plurality of unit cells each having a rectangular shape in plan view are arranged side by side, the unit cell being provided with a flexible outer member; and a first heat transfer member including a flexible bag member filled with a heat-transferring substance having fluidity, the first heat transfer member being configured to transfer heat generated from the unit cells to the housing. At least one of side faces of the unit cell assembly is provided with a connecting portion in which current-collecting terminals projecting from the respective unit cells are connected to one another. The first heat transfer member is provided between at least one of the side faces of the unit cell assembly, excluding the side face of the unit cell assembly that is provided with the connecting portion, and a side face of the housing that is adjacent to the side face of the unit cell assembly. The first heat transfer member is positioned in a middle part in a direction of arrangement of the unit cells.

The above first heat transfer member including the flexible bag member filled with the heat-transferring substance having fluidity is freely deformable. Therefore, even if the outer member covering each of the unit cells is made of a flexible (easily deformable) material, a satisfactory area of contact between the unit cell and the first heat transfer member is provided. Accordingly, heat is satisfactorily dissipated from those unit cells that are in contact with the first heat transfer member (unit cells positioned in the middle part in the direction of arrangement of the unit cells, and hereinafter also referred to as unit cells in the middle part). This lowers the temperatures of the unit cells in the middle part, whose temperatures tend to rise more easily than unit cells positioned at the ends in the direction of arrangement of the unit cells (unit cells positioned in any part excluding the middle part in the direction of arrangement of the unit cells, and hereinafter also referred to as unit cells at the ends). Consequently, the temperatures of all unit cells are equalized. Therefore, the fast deterioration of only the unit cells in the middle part is suppressed.

Furthermore, since the first heat transfer member includes the flexible bag member filled with the heat-transferring substance having fluidity (that is, unless the first heat transfer member has a structure in which hardened silicone resin is fixedly provided on any side faces of the unit cell assembly), problems such as the difficulty in releasing the silicone resin from the unit cell assembly that may occur when the unit cell assembly is removed from the housing for the purpose of exchanging the unit cell assembly with a new one or any other purposes are avoided. Therefore, the unit cell assembly is easily recyclable.

Another assembled cell includes a housing having a closed-end rectangular cylindrical shape; a unit cell assembly housed in the housing and in which a plurality of unit cells each having a rectangular shape in plan view are arranged side by side, the unit cell being provided with a flexible outer member; and a first heat transfer member made of a flexible sheet and configured to transfer heat generated from the unit cells to the housing. At least one of side faces of the unit cell assembly is provided with a connecting portion in which current-collecting terminals projecting from the respective unit cells are connected to one another. The first heat transfer member is provided between at least one of the side faces of the unit cell assembly, excluding the side face of the unit cell assembly that is provided with the connecting portion, and a side face of the housing that is adjacent to the side face of the unit cell assembly. The first heat transfer member is positioned in a middle part in a direction of arrangement of the unit cells.

The first heat transfer member is made of the flexible sheet. Therefore, as with the above case, even if the outer member covering each of the unit cells is made of a flexible (easily deformable) material, a satisfactory area of contact between the unit cell and the first heat transfer member is provided. Accordingly, the temperatures of all unit cells are equalized. Therefore, the fast deterioration of only the unit cells in the middle part is suppressed. Furthermore, since the first heat transfer member is a sheet, the unit cell assembly is easily recyclable.

Examples of the flexible sheet include a gel sheet (for example, an acrylic gel named SARCON NR-c manufactured by Fuji Polymer Industries Co., Ltd.). If such a gel sheet is employed, since the gel sheet has an adhesive force, the gel sheet is allowed to be directly pasted to the cell assembly. The cell assembly in this state can be housed in the housing. Consequently, if a gel sheet is employed, a first supporting projection and a second supporting projection to be described below are omittable. Therefore, the configuration of the assembled cell is simplified. Note that the unit cell assembly may alternatively be housed in the housing with the gel sheet directly pasted to the housing. In such a case also, the first supporting projection and the like are omittable. Furthermore, since the adhesive force of the gel sheet is not so large, the gel sheet is easily releasable from the unit cell assembly. Hence, no problems arise when the unit cell assembly is recycled. Moreover, the gel sheet is not limited to the above non-silicone gel sheet and may be a silicone gel sheet.

While an aluminum laminate film is one of examples of the flexible outer member, the flexible outer member is not limited thereto.

It is desirable that a first supporting projection that positions the first heat transfer member be fixed at a position on a side face of the housing that corresponds to one end of the first heat transfer member in the direction of arrangement of the unit cells.

In such a configuration, the first heat transfer member is provided at a predetermined position by simply bringing the first heat transfer member into contact with the first supporting projection. Hence, there is no need to fix the first heat transfer member to any side faces of the housing, making the manufacture of the assembled cell easier.

It is desirable that a second supporting projection be fixed at another position on the side face of the housing that corresponds to another end of the first heat transfer member in the direction of arrangement of the unit cells, and that the first heat transfer member be held between the second supporting projection and the first supporting projection.

Such a configuration in which the first heat transfer member is held between the two supporting projections suppresses the occurrence of problems that may be seen when the unit cell assembly is inserted into the housing, such as the displacement of the first heat transfer member that may be pushed by the unit cell assembly (for example, it may drop if unit cell assemblies are stacked vertically), and the presence of the first heat transfer member preventing the insertion of the unit cell assembly.

It is desirable that a top plate and a bottom plate be provided at one end and another end, respectively, of the unit cell assembly in the direction of arrangement of the unit cells, that a pressing member that presses the unit cells in the direction of arrangement of the unit cells be fixed to the top plate and the bottom plate, and that the pressing member include a holding portion that holds the first heat transfer member.

In such a configuration in which the holding portion that holds the first heat transfer member is included in the pressing member, the first heat transfer member is provided at a predetermined position without providing the two supporting projections.

It is desirable that the first heat transfer member be provided on a side face of the unit cell assembly, the side face extending in the direction of arrangement.

Such a configuration effectively improves the thermal conductivity by utilizing directions of good thermal conduction.

It is desirable that the first heat transfer member be directly in contact with the side face of the housing and the side face of the unit cell assembly.

In such a configuration, the number of components included in the assembled cell is small enough to realize a low-cost assembled cell.

It is desirable that a second heat transfer member that has higher thermal conductivity than the first heat transfer member be provided between the first heat transfer member and the side face of the housing in such a manner as to be in contact with the first heat transfer member, and that the first heat transfer member be in contact with the side face of the unit cell assembly while the second heat transfer member be in contact with the side face of the housing.

In such a configuration, the thermal conductivity between the cell assembly and the housing is improved more than in a case where only the first heat transfer member is provided between the cell assembly and the side face of the housing. Hence, the rise of the temperatures of the unit cells in the middle part of the unit cell assembly is further suppressed.

It is desirable that a structure including a flexible bag member filled with a heat-transferring substance having fluidity or a third heat transfer member made of a flexible sheet and having a smaller heat transfer coefficient than the first heat transfer member be provided on an outer side of one end of the first heat transfer member in the direction of arrangement of the unit cells and/or on an outer side of another end of the first heat transfer member in the direction of arrangement of the unit cells.

If the thermal conductivity of the first heat transfer member is extremely high or in any similar situation, the temperatures of the unit cells in the middle part may become lower than the temperatures of the unit cells at the ends. In such a case, if a third heat transfer member having a lower heat transfer coefficient than the first heat transfer member is provided on the outer side of one end of the first heat transfer member (for example, on the upper side of the first heat transfer member if unit cell assemblies are stacked vertically) or on the outer side of the other end of the first heat transfer member (for example, on the lower side of the first heat transfer member if unit cell assemblies are stacked vertically), the unit cells at that end are also cooled to some extent. Accordingly, while the temperature of the unit cell assembly as a whole is lowered, the temperatures of all unit cells are equalized.

As with the case of the first heat transfer member, the third heat transfer member may also be a gel sheet.

### Embodiment

The present invention will further be described in detail on the basis of an embodiment. The present invention is not limited to the following embodiment in any way and can be embodied with appropriate changes made thereto without changing the essence of the invention.

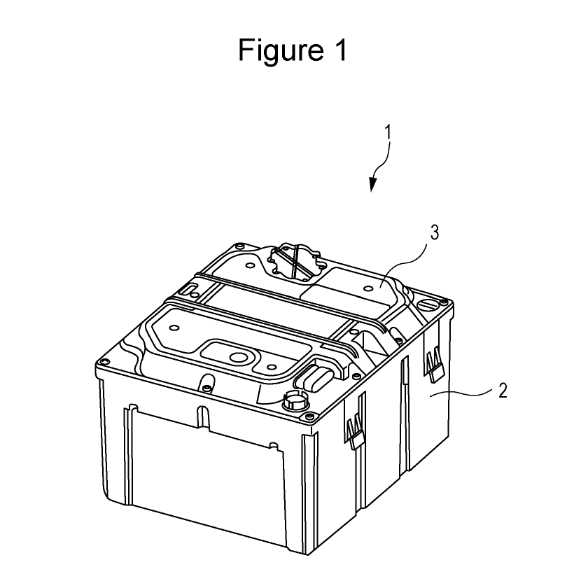

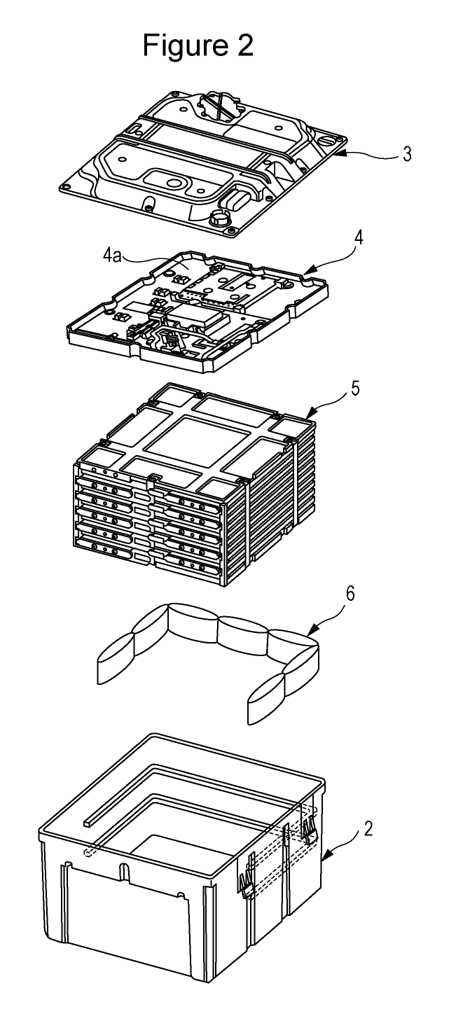

As illustrated in FIG. 1, an assembled cell 1 according to the present invention includes a housing 2 having a closed-end rectangular cylindrical shape and made of resin, and an outer lid 3 attached to an open portion of the housing 2. As illustrated in FIG. 2, the housing 2 houses an inner lid (lid member) 4 fixed to the opening of the housing, a unit cell assembly (core pack) 5 housed in the housing 2, and a first heat transfer member 6 that transfers heat generated from the unit cell assembly 5 to the housing 2.

An upper face 4a of the inner lid 4 is provided with electronic components that control the assembled cell. As illustrated in FIG. 4, the unit cell assembly 5 includes ten unit cells 10 that are stacked in the thickness direction thereof. The unit cell assembly 5 further includes a resin top plate 11 and a resin bottom plate 12 that are provided at the top and bottom ends, respectively, thereof. Plate-like pressing members 13 are each fixed to the top plate 11 and the bottom plate 12 in such a manner as to extend over the stack of the unit cells 10. The pressing members 13 apply a structural pressure to the unit cells 10.

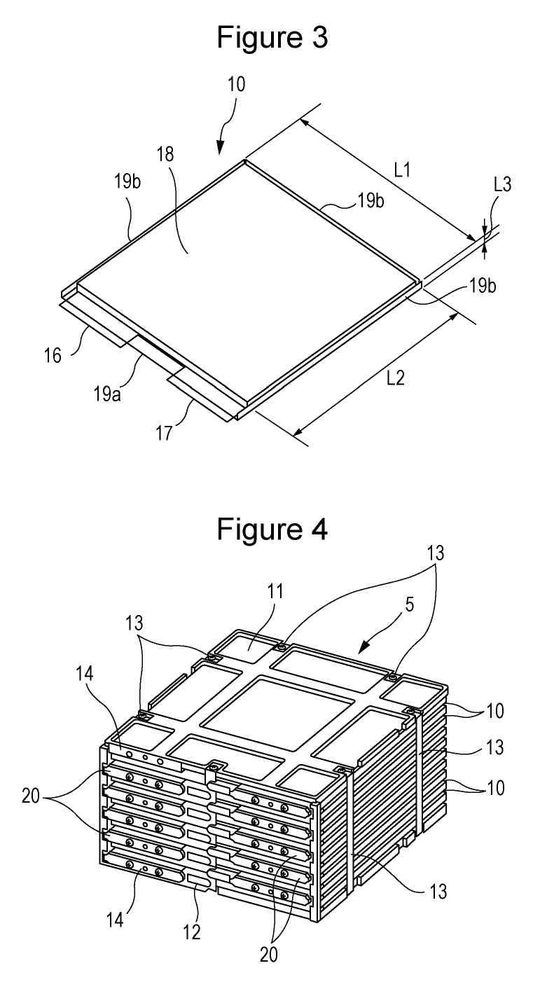

As illustrated in FIG. 3, the unit cells 10 each have a rectangular shape in plan view and has a structure in which an electrode member (not illustrated) including a positive electrode, a negative electrode, and a separator is packed in an outer member 18 with an electrolytic solution provided therein. The outer member 18 is made of two aluminum laminate films.

Furthermore, an aluminum positive electrode terminal 16 and a copper negative electrode terminal 17 project from the aluminum laminate films on one side of the unit cell 10. The outer member 18 has welded portions 19a and 19b provided on the periphery thereof and in which the two aluminum laminate films are welded to each other. The fused portions 19b on the three sides excluding the welded portion 19a from which the positive and negative electrode terminals (current-collecting terminals) 16 and 17 project are bent substantially perpendicularly to the top and bottom faces of the unit cell 10 (in such a manner as to be substantially parallel to the side faces of the unit cell 10). Thus, the size of the unit cell 10 (the unit cell assembly 5) is reduced. The unit cell 10 has the following dimensions: a width L1 of 156 mm, a length L2 of 144 mm, and a thickness L3 of 10 mm. Furthermore, the unit cell 10 has a capacity of 40 Ah.

Adjacent ones of the positive electrode terminals 16 and the negative electrode terminals 17 of the unit cells 10 (each of the positive electrode terminals 16 and a corresponding one of the negative electrode terminals 17) are connected to each other with connecting terminals (connecting portions) 20, whereby the unit cells 10 are connected in series. External extraction terminals 14 are provided at two respective ends of a conduction path. The connecting terminals 20 are not necessarily provided. Instead, each positive electrode terminal 16 and a corresponding negative electrode terminal 17 that are adjacent to each other may be electrically connected to each other by being simply welded to each other. Moreover, the unit cells 10 are not limited to be connected in series and may be connected in parallel. Alternatively, a combination of series connections and parallel connections may be employed.

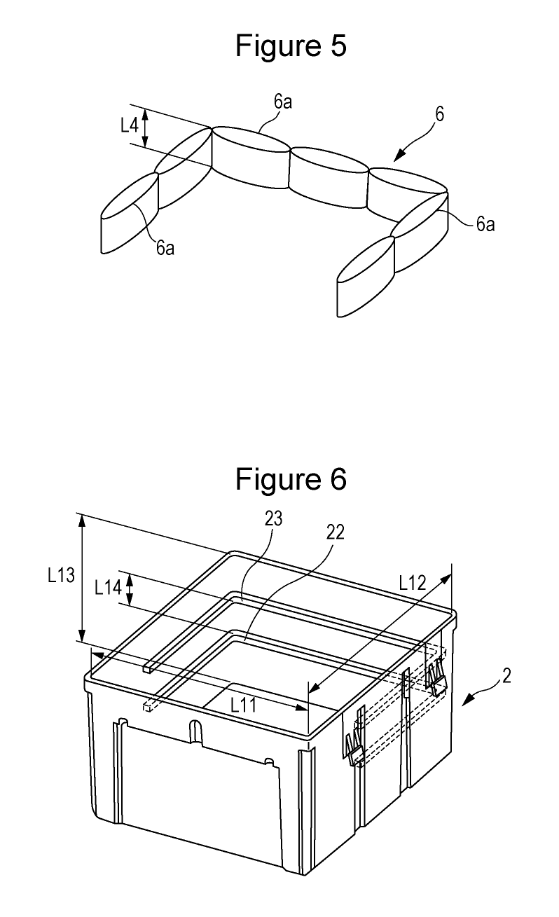

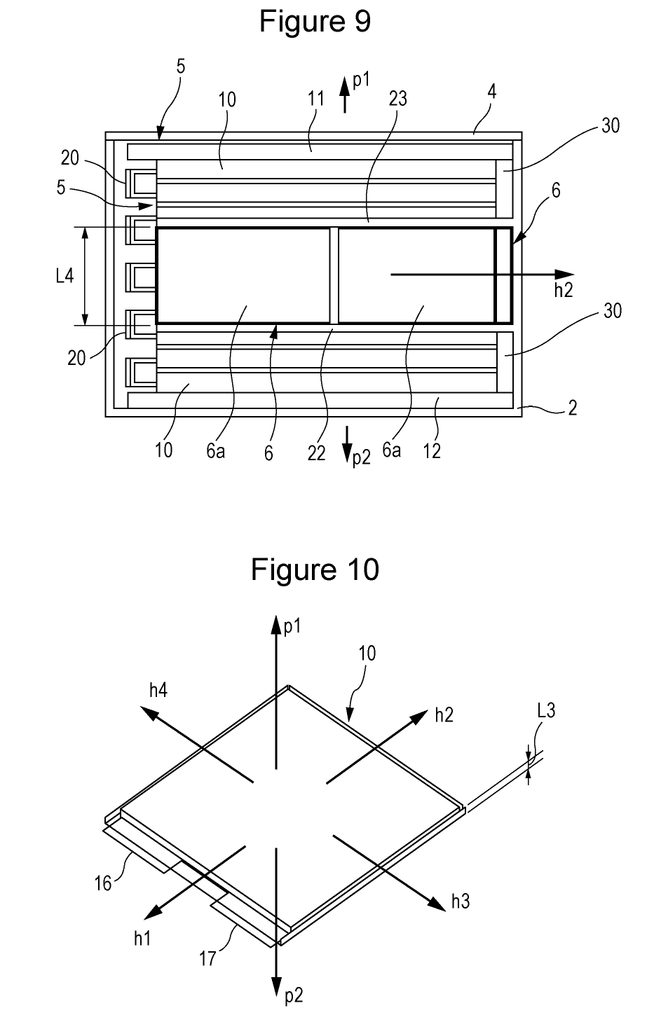

As illustrated in FIG. 5 and FIGS. 7 to 9, the first heat transfer member 6 includes a plurality of flexible bag members (made of polycarbonate film) 6a connected to one another and filled with a heat-transferring substance having fluidity (made of silicone gel [a heat-dissipating, heat-setting silicone rubber/gel X32-2020 manufactured by Shin-Etsu Chemical Co., Ltd.]). The connected portions are provided such that the first heat transfer member 6 is satisfactorily deformable (perpendicularly bendable). Therefore, the first heat transfer member 6 is easily deformable into, for example, a substantially rectangular U shape as illustrated in associated drawings. The first heat transfer member has a height L4 of 40 mm. In a state where the first heat transfer member 6 is positioned between the unit cell assembly 5 and the housing 2, the first heat transfer member 6 is in contact with four of the ten unit cells 10 that are in a middle part in a stacking direction.

As illustrated in FIG. 6, the housing 2 has a width L11 of 180 mm, a length L12 of 196 mm, and a height L13 of 115 mm. Furthermore, a first supporting projection 22 and a second supporting projection 23 extend over three of the four side faces of the housing 2, excluding the one that is to be adjacent to the side face of the unit cell assembly 5 on which the connecting terminals 20 are provided. A gap L14 between the first supporting projection 22 and the second supporting projection 23 is substantially the same as the height L4 of the first heat transfer member 6. This allows the first heat transfer member 6 to be held between the first supporting projection 22 and the second supporting projection 23. Accordingly, the occurrence of problems that may be seen in the process of manufacturing the assembled cell (when the unit cell assembly 5 is inserted into the housing 2) is suppressed, such as the dropping of the first heat transfer member 6 that may be pushed by the unit cell assembly 5, or the presence of the first heat transfer member 6 preventing the insertion of the unit cell assembly 5.

The first supporting projection 22 is provided near the upper end of the third one of the unit cells 10 counting from the bottom of the unit cell assembly 5. On the other hand, the second supporting projection 23 is provided near the lower end of the third one of the unit cells 10 counting from the top of the unit cell assembly 5. Hence, the first heat transfer member 6 is in contact with four unit cells 10 positioned in the middle of the ten unit cells 10. Therefore, heat generated from mainly the four unit cells 10 are transmitted to the housing 2 via the first heat transfer member 6.

As described above, the first heat transfer member 6 includes the flexible bag members 6a filled with silicone gel and is therefore freely deformable to some extent. Hence, even if the outer member 18 covering each unit cell 10 is made of any flexible (easily deformable) aluminum laminate film, a satisfactory area of contact between the unit cell 10 and the first heat transfer member 6 is provided. This suppresses the rise of the temperatures of those unit cells (the four unit cells positioned in the middle part of the unit cell assembly 5) 10 that are in contact with the first heat transfer member 6 and whose temperatures tend to rise more easily than those unit cells (the six unit cells positioned in any parts of the unit cell assembly 5 excluding the middle part) 10 that are not in contact with the first heat transfer member 6. Consequently, the temperatures of all unit cells 10 are equalized. Therefore, the fast deterioration of only the four unit cells 10 positioned in the middle part is suppressed.

To fully exert the above advantageous effect, it is desirable that a thickness L7 of the first supporting projection 22 and a thickness L8 of the second supporting projection 23 be each small while appropriately producing the supporting functions, and that spaces 30 be provided below the first supporting projection 22 and above the second supporting projection 23, respectively. This is because of the following reasons. If the spaces 30 are provided below the first supporting projection 22 and above the second supporting projection 23, the dissipation of heat generated from the six unit cells 10 positioned at the two ends of the unit cell assembly 5 (the unit cells 10 whose heat is easier to dissipate than the four unit cells 10 positioned in the middle part of the unit cell assembly 5) is suppressed suitably. That is, as described above, the temperature difference between the unit cells 10 at the two ends and the unit cells 10 in the middle part is reduced.

If the thickness L7 of the first supporting projection 22 and the thickness L8 of the second supporting projection 23 are made so large that no spaces 30 are provided between the housing and the two ends of the unit cell assembly 5, the heat dissipation from the six unit cells 10 at the two ends of the unit cell assembly 5 increases. Therefore, the heat dissipation from the unit cells 10 in the middle part of the unit cell assembly 5 needs to be increased more. However, such a configuration tends to be difficult to realize. Nevertheless, if the cooling effect exerted by the first heat transfer member 6 is good, third heat transfer members 25 and 26 may also be provided in the spaces 30 as described separately below.

The first heat transfer member 6 includes the bag members 6a filled with silicone gel (that is, no hardened silicone resin is present on the side faces of the unit cell assembly 5). This prevents the occurrence of problems such as the difficulty in releasing the silicone resin from the unit cell assembly 5 that may occur when the unit cell assembly 5 is removed from the housing 2 for exchanging the unit cell assembly with a new one or for any other purposes. Therefore, the recycling of the unit cell assembly 5 and other work are easily performed.

Furthermore, if the silicone gel contains at least one kind of metal filler selected from the group consisting of magnesium oxide (MgO), magnesium carbonate (MgCO₃), magnesium hydroxide (Mg(OH)₂), silica (SiO₂), alumina (Al₂O₂), boron nitride (BN), aluminum nitride (AlN), and titanium nitride (TiN), the thermal conductivity is improved.

The assembled cell configured as described above was manufactured in the following manner.

### [Manufacture of Unit Cells]

First, positive electrodes and negative electrodes were manufactured using LiCoO₂ as a positive electrode active material, aluminum foil as a core of each positive electrode, carbon as a negative electrode active material, and copper foil as a core of each negative electrode. In this step, the positive electrodes and the negative electrodes were cut out so as to have respective predetermined sizes, and positive and negative electrode tabs were formed by letting portions of the respective cores that were uncovered with the active materials extend for current collection. Subsequently, separators were provided between the positive electrodes and the negative electrodes such that a positive electrode, a separator, a negative electrode, and a separator were stacked in that order. Consequently, negative electrodes were present at the two ends. The stack included thirty positive electrodes and thirty-one negative electrodes.

Subsequently, the positive and negative electrode tabs of each positive electrode and a corresponding negative electrode that had been stacked were welded to a positive electrode terminal 16 and a negative electrode terminal 17, respectively, by ultrasonic welding. Then, the stack of electrode members was placed in an outer member 18 made of an aluminum laminate, and three sides of the stack excluding the side having the welded portion 19a from which the positive and negative electrode terminals (connecting terminals) 16 and 17 projected were sealed with heat. Furthermore, after injecting an electrolytic solution into the outer member 18 from an open portion of the outer member 18, the open portion was sealed with heat. Lastly, the fused portions 19b on the three sides excluding the side having the welded portion 19a from which the positive and negative electrode terminals (current-collecting terminals) 16 and 17 projected were folded substantially perpendicularly to the top and bottom faces of the unit cell 10. Thus, the unit cell 10 was obtained.

### [Manufacture of Unit Cell Assembly]

First, ten unit cells 10 were manufactured and were stacked in the thickness direction (vertical direction), and a resin top plate 11 and a resin bottom plate 12 were placed on the outer sides of unit cells 10 that are positioned at the top and bottom ends, respectively. Subsequently, pressing members 13 for applying a structural pressure to the unit cells 10 were each fixed to the top plate 11 and the bottom plate 12. Then, the positive electrode terminals 16 and the negative electrode terminals 17 of the ten unit cells 10 were connected in series by using connecting terminals 20, and external extraction terminals 14 were provided at two ends of a conduction path. Thus, a unit cell assembly 5 was obtained.

### [Manufacture of First Heat Transfer Member]

Simultaneously with the manufacture of the unit cell assembly 5, silicone gel was injected into a bag member 6a, which is made of polycarbonate film, from an opening of the bag member 6a, and the opening of the bag member 6a was sealed. Then, seven bag members 6a each obtained in this manner were connected to one another. Thus, a first heat transfer member 6 was obtained.

### [Manufacture of Assembled Cell]

First, the first heat transfer member 6 was placed between the first supporting projection 22 and the second supporting projection 23 on the housing 2 while bending the first heat transfer member 6 into a substantially rectangular U shape, whereby the first heat transfer member 6 was made to be held between the two supporting projections 22 and 23. Subsequently, after the unit cell assembly 5 was inserted into a space defined by the housing 2, an inner lid 4 was fixed to the inner wall of the open portion of the housing 2. Lastly, an outer lid 3 was fixed to an end facet at the opening of the housing 2 in such a manner as to cover the inner lid 4. Thus, an assembled cell 1 was obtained.

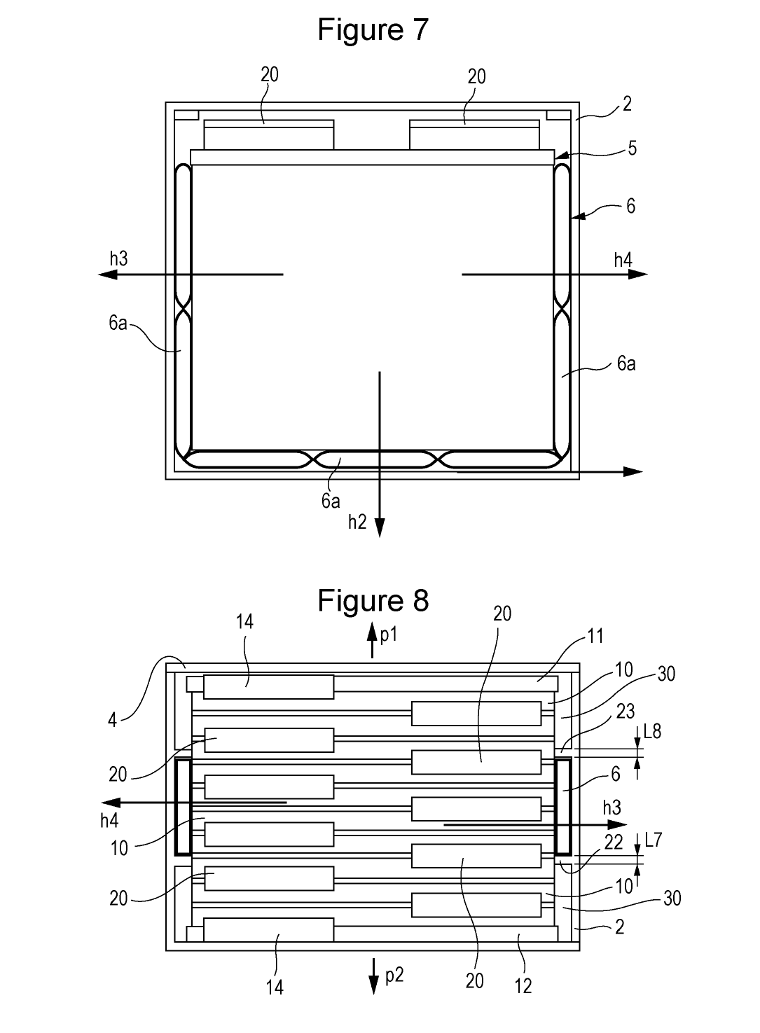

In the above assembled cell 1, as illustrated in FIGS. 7 to 9, the first heat transfer member 6 extends over side faces of the unit cell assembly that each extend in the direction of arrangement.

As illustrated in FIG. 10, there are some directions in which thermal conductivity is high (directions of good thermal conduction) in each unit cell 10. As described above, a plurality (ten) of unit cells 10 are stacked, i.e., arranged, in the direction of thickness L3, i.e., upward and downward directions p1 and p2 illustrated in FIG. 10, whereby the unit cell assembly 5 is obtained. In this state, heat is relatively difficult to conduct in the direction of arrangement of the unit cell assembly 5 (in the upward and downward directions p1 and p2 in FIG. 10). In contrast, the thermal conductivity is high in directions perpendicular to the direction of arrangement of the unit cell assembly 5, i.e., in directions parallel to the top and bottom faces of each unit cell 10 (in horizontal directions h1, h2, h3, and h4 illustrated in FIG. 10). In other words, the directions perpendicular to the direction of arrangement of the unit cell assembly 5 correspond to the directions of good thermal conduction. While FIG. 10 illustrates, as representative directions of good thermal conduction, the four directions h1, h2, h3, and h4 that are parallel to the direction of width L1 and the direction of length L2 of the unit cell 10 and are at 90° with respect to one another, the directions of good thermal conduction are actually not limited to those directions. Any directions (any directions within an angle of 360°) that are perpendicular to the direction of arrangement of the unit cell assembly 5, i.e., any directions parallel to the top and bottom faces of the unit cell 10, are included.

Hence, if any heat transfer member is provided on each of four of the six side faces of the unit cell assembly 5 that intersect the directions of good thermal conduction (the horizontal directions h1, h2, h3, and h4), i.e., on the four side faces each extending in the direction of arrangement, good thermal conductivity is obtained effectively by utilizing the directions of good thermal conduction. In such a case, as described above, any directions that are perpendicular to the direction of arrangement of the unit cell assembly 5 correspond to the directions of good thermal conduction. Therefore, the heat transfer member may be provided on any of the four side faces extending in the direction of arrangement. Specifically, the heat transfer member only needs to be provided on at least one of the three side faces excluding the side face provided with the connecting terminals 20, i.e., the side face from which the positive electrode terminal 16 and the negative electrode terminal 17 project (an end in the lower-left direction h1 illustrated in FIG. 10). In the present embodiment, as described above, the first heat transfer member 6 extends over all of the three of the four side faces of the unit cell assembly 5 extending in the direction of arrangement, excluding the side face provided with the connecting terminals 20. Hence, as illustrated in FIGS. 7 to 9, good thermal conductivity is effectively provided by utilizing the directions of good thermal conduction h2, h3, and h4 that intersect the foregoing three side faces.

### (Modifications)

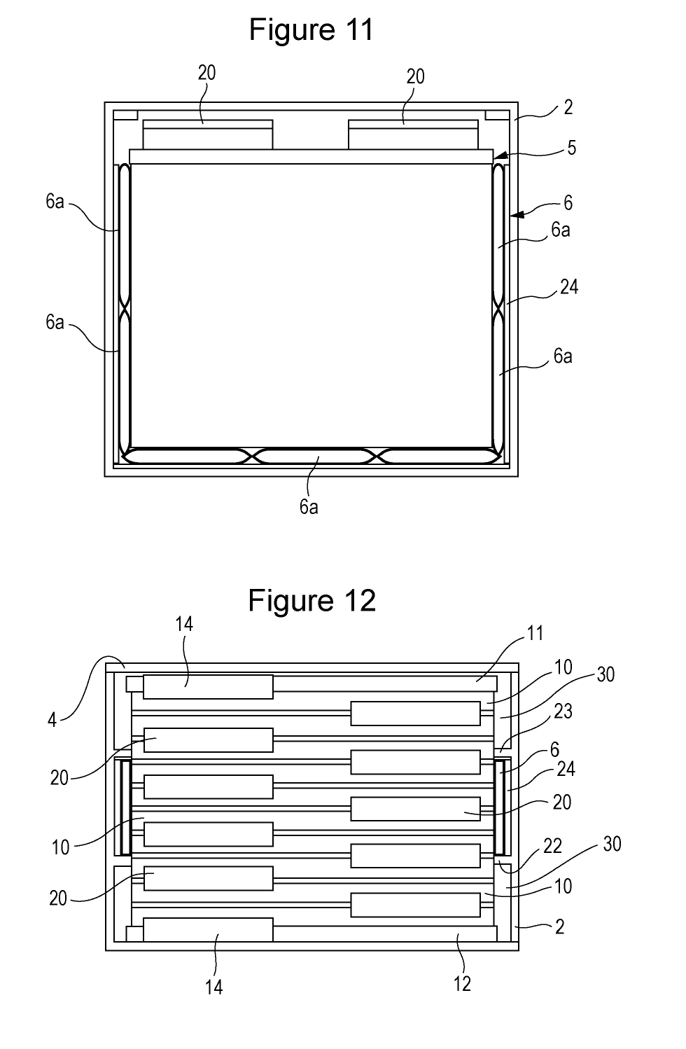

(1) As illustrated in FIGS. 11 and 12, a second heat transfer member 24 (made of metal such as aluminum or stainless steel or an alloy, for example) having higher thermal conductivity than the first heat transfer member may be provided between the first heat transfer member 6 and side faces of the housing 2. In such a configuration, since a member that is in contact with some unit cells 10 is the first heat transfer member 6 that is freely deformable, a satisfactory area of contact between the first heat transfer member 6 and the unit cells 10 is provided. Moreover, if the second heat transfer member 24 having higher thermal conductivity than the first heat transfer member is present between the first heat transfer member 6 and the side faces of the housing 2, the thermal conductivity between the cell assembly 5 and the housing 2 becomes higher than in the case where only the first heat transfer member 6 is present between the cell assembly 5 and the side faces of the housing 2. Therefore, the rise of the temperatures of the unit cells 10 in the middle part of the unit cell assembly 5 is more suppressed. As described above, the housing 2 is made of resin that is less deformable. Therefore, even if the second heat transfer member 24 is made of metal or the like, a satisfactory area of contact between the second heat transfer member 24 and the housing 2 is provided.

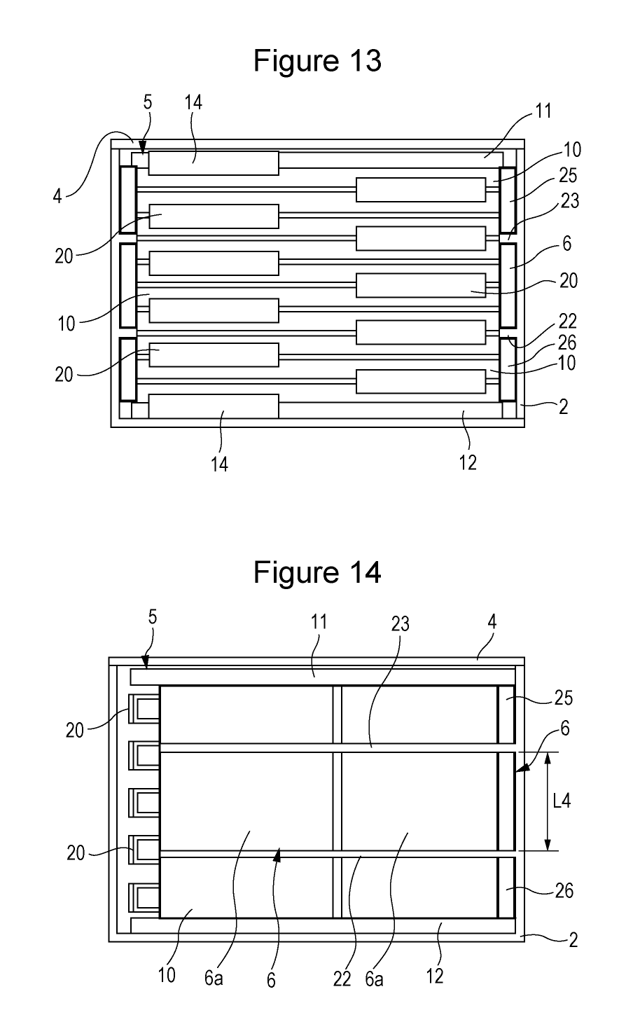

(2) As illustrated in FIGS. 13 and 14, third heat transfer members 25 and 26 each having a lower heat transfer coefficient than the first heat transfer member 6 may be provided above and below the first heat transfer member 6, respectively. Specifically, the third heat transfer member 25 is in contact with side faces of the housing 2 and three unit cells 10 that are in an upper part of the unit cell assembly 6, and the third heat transfer member 26 is in contact with side faces of the housing 2 and three unit cells 10 that are in a lower part of the unit cell assembly 6. In such a configuration, while the rise of the temperatures of the unit cells 10 in the middle part of the unit cell assembly 5 is suppressed, the rise of the temperature of the unit cell assembly 5 as a whole is also suppressed. To lower the heat transfer coefficients of the third heat transfer members 25 and 26 than that of the first heat transfer member 6, silicone gel (for example, a heat-dissipating, heat-setting silicone rubber/gel X32-2152 manufactured by Shin-Etsu Chemical Co., Ltd.) having a lower heat transfer coefficient than the heat-transferring substance provided in the bag members 6a of the first heat transfer member 6 may be employed as the heat-transferring substance provided in bag members of the third heat transfer members 25 and 26, for example.

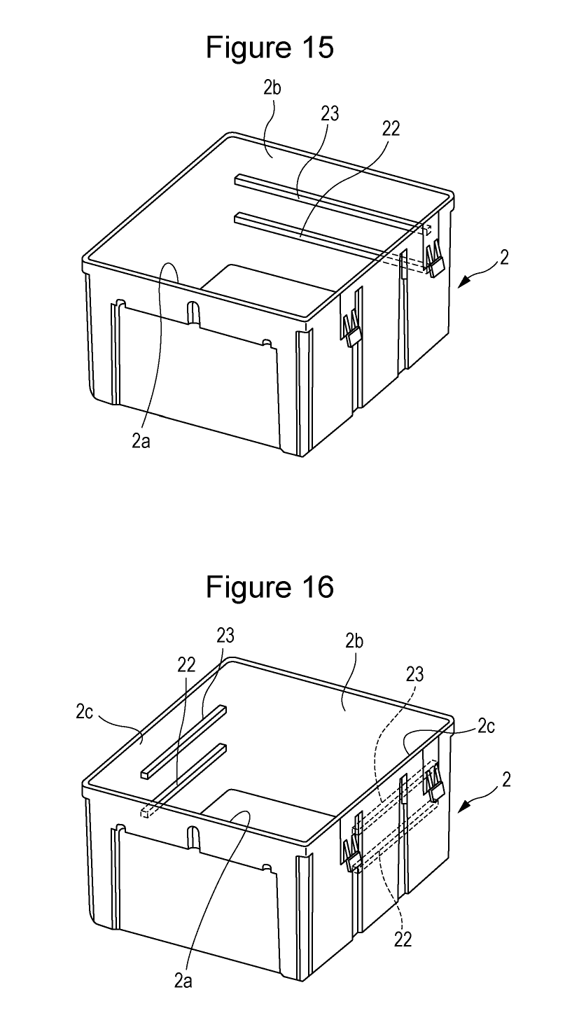

(3) As illustrated in FIG. 15, the first supporting projection 22 and the second supporting projection 23 may each be provided only on a side face 2b of the housing 2 that is opposite a side face (a side face corresponding to the side face of the unit cell assembly 5 provided with the connecting terminals 20) 2a, and the first heat transfer member 6 may be held between only the two supporting projections 22 and 23. Alternatively, as illustrated in FIG. 16, the first supporting projection 22 and the second supporting projection 23 may be provided on each of two side faces 2c excluding the side face 2a and the side face 2b, and the first heat transfer member 6 may be held between only the supporting projections 22 and 23. That is, the first heat transfer member 6 only needs to be provided on at least one of the three side faces 2b and 2c of the housing 2 excluding the side face 2a.

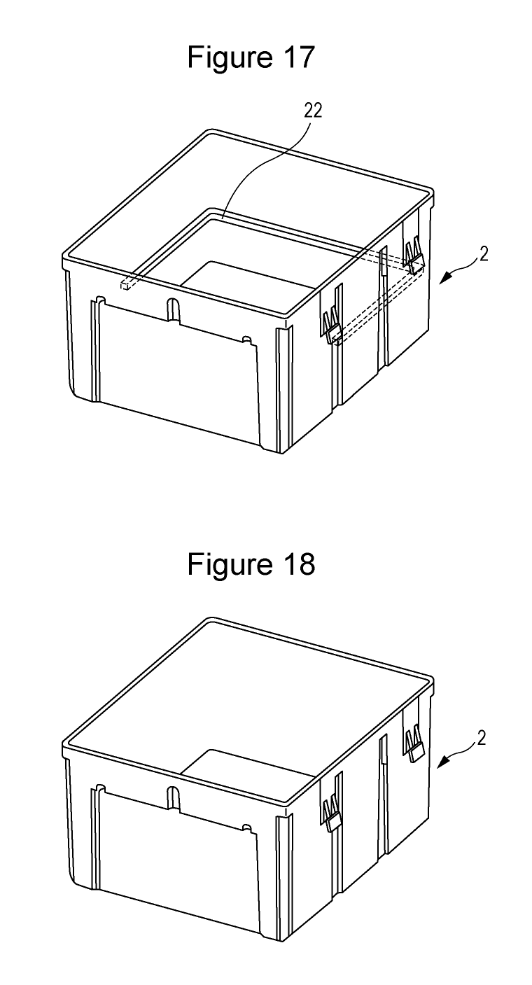

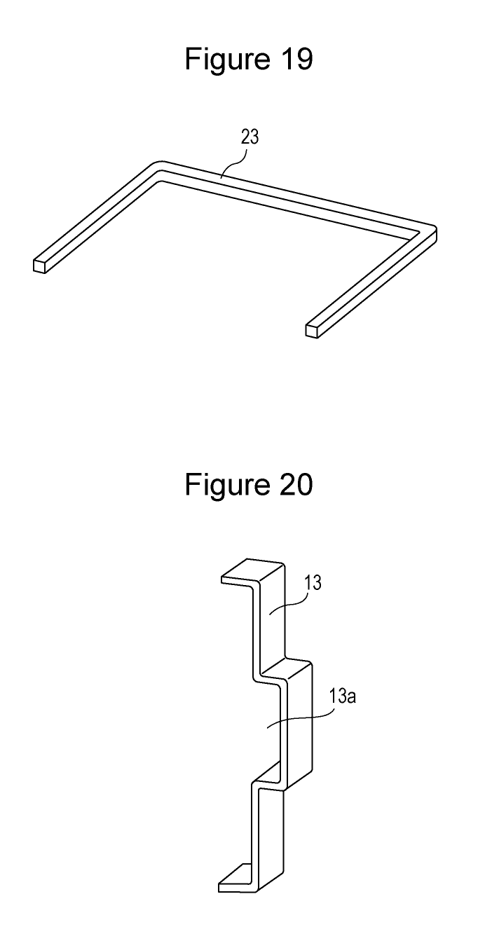

(4) As illustrated in FIG. 17, only the first supporting projection 22 may be provided over some side faces of the housing 2, that is, the second supporting projection 23 may be omitted. In such a configuration also, the first heat transfer member 6 is supportable. However, if the third heat transfer members 25 and 26 are provided in addition to the first heat transfer member 6 or if the first heat transfer member 6 is desired to be supported more assuredly, it is preferable that a second supporting projection 23 having a rectangular U shape as illustrated in FIG. 19 be provided above the first heat transfer member 6 after the first heat transfer member 6 is positioned.

Furthermore, as illustrated in FIG. 18, the two supporting projections 22 and 23 may be omitted from the side faces of the housing 2. In such a case, however, the first heat transfer member 6 needs to be fixed to any side faces of the housing 2 by pasting the first heat transfer member 6 to the side faces of the housing 2 or by any other way.

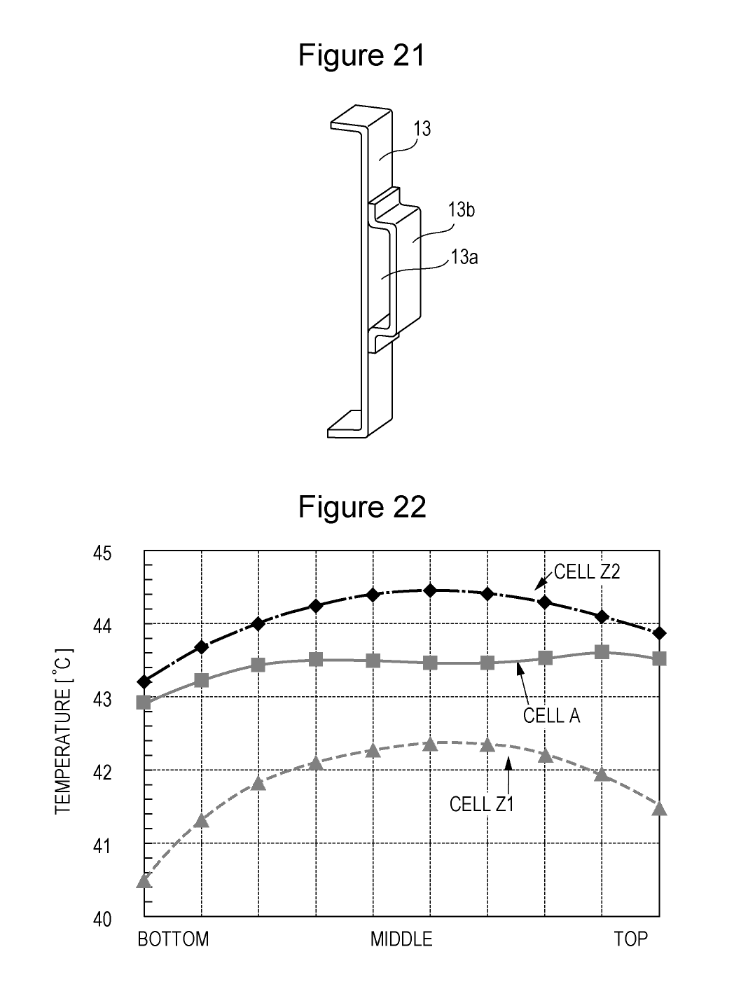

(5) As illustrated in FIG. 20, the pressing members 13 may each have a first-heat-transfer-member-holding portion 13a in a middle part thereof. If the configuration illustrated in FIG. 20 is employed, however, the pressing member 13 may bend and the pressure applied to the unit cell assembly 5 may be insufficient. In that case, as illustrated in FIG. 21, a holding member 13b may be fixed to the pressing member 13, whereby a first-heat-transfer-member-holding portion 13a may be provided.

(6) The materials of the bag members forming the first heat transfer member and the third heat transfer member are not limited to polycarbonate film described above and only needs to be a cold-resistant and heat-resistant material, for example, laminate film such as nylon (polyamide) film or EVA, or the like. Moreover, if a stretchable material is employed as the materials of the bag members forming the two heat transfer members, the heat transfer members are easily bendable even without any connected portions. That is, the first heat transfer member and the third heat transfer member are each not limited to include a plurality of bag members connected to one another but may each include one bag member filled with silicone gel.

Moreover, the heat-transferring substance having fluidity that is provided in the bag member is not limited to silicone gel and may be a potting material [KE1051J(A/B) or KE1052J(A/B) manufactured by Shin-Etsu Chemical Co., Ltd.] or a liquid material such as silicone oil.

(7) While the above embodiment concerns a case where the ratio of the number of unit cells that are in contact with the first heat transfer member to the number of all unit cells is 4/10, the ratio is not limited thereto. If the ratio is too small, however, the unit cells in the middle part of the unit cell assembly are not cooled smoothly. In contrast, if the ratio is too large, all of the unit cells included in the unit cell assembly are cooled. In such a case, the effect of cooling mainly the unit cells in the middle part of the unit cell assembly is not fully exerted. Considering such circumstances, the ratio of the number of unit cells that are in contact with the first heat transfer member to the number of all unit cells is preferably regulated so as to be ⅓ or larger and ½ or smaller. Particularly when the number of unit cells that are stacked is large (about twenty, for example), the temperatures of the unit cells in the middle part tend to become rise easily. Therefore, the ratio of the number of unit cells that are in contact with the first heat transfer member to the number of all unit cells is preferably regulated so as to be large (about ½, for example).

(8) The unit cell assembly is not limited to include unit cells that are stacked in the vertical direction and may include unit cells that are arranged side by side in the horizontal direction.

(9) The unit cells are each not limited to have a positive electrode terminal and a negative electrode terminal both projecting from one side thereof. While the positive electrode terminal projects from one side, the negative electrode terminal may project from a side different from the side from which the positive electrode terminal projects (for example, a side opposite the side from which the positive electrode terminal projects).

### (Experiment)

The effect (temperature distribution) of providing the first heat transfer member was examined. The results are graphed in FIG. 22.

An experiment was conducted by using three assembled cells described below [to examine Cell A and Cell Z1 in a simple manner, heat transfer between the unit cell assembly and the housing was realized by using gel as it was. That is, only the gel was present (no bag members were present) between the unit cell assembly and the housing].
Gel was provided only in an area between the unit cell assembly and the housing (excluding an area between the unit cell assembly and the housing where the connecting terminals 20 were present) and in a middle part of the unit cell assembly in the stacking direction (a part corresponding to middle four of the ten unit cells). An assembled cell thus obtained is hereinafter referred to as Cell A.
Gel was provided in an area between the unit cell assembly and the housing (excluding an area between the unit cell assembly and the housing where the connecting terminals 20 were present) and over the entirety of the unit cell assembly in the stacking direction (over all of the ten unit cells). An assembled cell thus obtained is hereinafter referred to as Cell Z1.
No gel was provided between the unit cell assembly and the housing. An assembled cell thus obtained is hereinafter referred to as Cell Z2.

Cells A, Z1, and Z2 obtained as described above were charged and were made to discharge under the following conditions, and the temperatures thereof immediately after the completion of discharge were measured.

Conditions of Charging and Discharging

After each cell was charged with a constant current of 32 A [1.0 It] until the voltage reached 4.2 V, the charging was continued at the constant voltage until the current reached 1 A. Subsequently, the cell was made to discharge with a current of 48 A [1.5 It] until the voltage reached 3.5 V.

As can be seen clearly from FIG. 22, in Cell A in which gel was provided in an area between the unit cell assembly and the housing and only in the middle part of the unit cell assembly in the stacking direction, the temperature is generally lower than in Cell Z2 in which no gel was provided between the unit cell assembly and the housing. Particularly, the temperature is much lower in the middle part, showing that the temperature difference between the unit cells was extremely small. In Cell Z1 in which gel was provided in an area between the unit cell assembly and the housing and over the entirety of the unit cell assembly in the stacking direction, although the temperature is generally lower than in Cell Z2 in which no gel was provided between the unit cell assembly and the housing, it is clear that the temperature difference between the unit cells included therein remained large.

### INDUSTRIAL APPLICABILITY

The present invention is applicable to a motorcycle and so forth that are subject to operating environments that are harsh to the cells, such as an environment requiring continuous operation at high temperature.

### REFERENCE SIGNS LIST

1 assembled cell
2 housing
4 inner lid
5 unit cell assembly
6 first heat transfer member
6a bag member
10 unit cell
18 outer member
20 connecting terminal (connecting portion)

1. An assembled cell comprising:
a housing having a closed-end rectangular cylindrical shape;
a unit cell assembly housed in the housing and in which a plurality of unit cells each having a rectangular shape in plan view are arranged side by side, the unit cell being provided with a flexible outer member; and
a first heat transfer member including a flexible bag member filled with a heat-transferring substance having fluidity, the first heat transfer member being configured to transfer heat generated from the unit cells to the housing,
wherein at least one of side faces of the unit cell assembly is provided with a connecting portion in which current-collecting terminals projecting from the respective unit cells are connected to one another, and the first heat transfer member is provided between at least one of the side faces of the unit cell assembly, excluding the side face of the unit cell assembly that is provided with the connecting portion, and a side face of the housing that is adjacent to the side face of the unit cell assembly, the first heat transfer member being positioned in a middle part in a direction of arrangement of the unit cells.

2. An assembled cell comprising:
a housing having a closed-end rectangular cylindrical shape;
a unit cell assembly housed in the housing and in which a plurality of unit cells each having a rectangular shape in plan view are arranged side by side, the unit cell being provided with a flexible outer member; and
a first heat transfer member made of a flexible sheet and configured to transfer heat generated from the unit cells to the housing,
wherein at least one of side faces of the unit cell assembly is provided with a connecting portion in which current-collecting terminals projecting from the respective unit cells are connected to one another, and the first heat transfer member is provided between at least one of the side faces of the unit cell assembly, excluding the side face of the unit cell assembly that is provided with the connecting portion, and a side face of the housing that is adjacent to the side face of the unit cell assembly, the first heat transfer member being positioned in a middle part in a direction of arrangement of the unit cells.

3. The assembled cell according to claim 1, wherein the flexible outer member is made of aluminum laminate film.

4. The assembled cell according to claim 1, wherein a first supporting projection that positions the first heat transfer member is fixed at a position on a side face of the housing that corresponds to one end of the first heat transfer member in the direction of arrangement of the unit cells.

5. The assembled cell according to claim 4, wherein a second supporting projection is fixed at another position on the side face of the housing that corresponds to another end of the first heat transfer member in the direction of arrangement of the unit cells, and the first heat transfer member is held between the second supporting projection and the first supporting projection.

6. The assembled cell according to claim 1, wherein a top plate and a bottom plate are provided at one end and another end, respectively, of the unit cell assembly in the direction of arrangement of the unit cells, a pressing member that presses the unit cells in the direction of arrangement of the unit cells is fixed to the top plate and the bottom plate, and the pressing member includes a holding portion that holds the first heat transfer member.

7. The assembled cell according to claim 1, wherein the first heat transfer member is provided on a side face of the unit cell assembly, the side face extending in the direction of arrangement.

8. The assembled cell according to claim 1, wherein the first heat transfer member is directly in contact with the side face of the housing and the side face of the unit cell assembly.

9. The assembled cell according to claim 1, wherein a second heat transfer member that has higher thermal conductivity than the first heat transfer member is provided between the first heat transfer member and the side face of the housing in such a manner as to be in contact with the first heat transfer member, and the first heat transfer member is in contact with the side face of the unit cell assembly while the second heat transfer member is in contact with the side face of the housing.

10. The assembled cell according to claim 1, wherein a structure including a flexible bag member filled with a heat-transferring substance having fluidity or a third heat transfer member made of a flexible sheet and having a smaller heat transfer coefficient than the first heat transfer member is provided on an outer side of one end of the first heat transfer member in the direction of arrangement of the unit cells and/or on an outer side of another end of the first heat transfer member in the direction of arrangement of the unit cells.
